(19) United States
(12) Patent Application Publication
(10) Pub. No.: US 2011/0191828 A1
(43) Pub. Date: Aug. 4, 2011

(54) AUTHORIZATION AND TRACKING OF MODIFICATIONS TO MEDICAL DEVICES

(75) Inventors: Christopher Britton Gould, Valencia, CA (US); Sridhar Kothandaraman, Valencia, CA (US); Dennis Allen Vansickle, Lancaster, CA (US)

(73) Assignee: BOSTON SCIENTIFIC NEUROMODULATION CORPORATION, Valencia, CA (US)

(21) Appl. No.: 13/018,855

(22) Filed: Feb. 1, 2011

Related U.S. Application Data
(60) Provisional application No. 61/300,758, filed on Feb. 2, 2010.

(51) Int. Cl. G06F 21/00

(52) U.S. Cl. 726/4

(57) ABSTRACT

A system and method for authorizing and tracking a modification to a medical device are provided. The modification may be an installation of software or firmware, an upgrade of software or firmware, an enablement of a feature, and/or a disablement of a feature. The system includes a server for generating and transmitting an authorization key before the modification can be performed. The system also includes a device for generating a confirmation key and transmitting the confirmation key to the server after the modification has been performed. The server is configured for updating a database with information regarding the modification performed on the medical device. In this manner, the system avoids performing unauthorized modifications to a medical device and efficiently traces authorized modifications made to the medical device.

### RELATED APPLICATION

The present application claims the benefit under 35 U.S.C. §119 to U.S. provisional patent application Ser. No. 61/300,758, filed Feb. 2, 2010. The foregoing application is hereby incorporated by reference into the present application in its entirety.

### FIELD OF THE INVENTION

The present inventions relate to methods and systems for authorizing and tracking modifications to medical devices. More particularly, the present inventions relate to methods and systems for authorizing and tracking an installation of software or firmware, an upgrade of software or firmware, an enablement of a feature, and/or a disablement of a feature.

### BACKGROUND OF THE INVENTION

Once a medical device leaves its manufacturing location, the manufacturer is required to track the location of medical device for safety reasons (e.g., in case of a product recall). In addition to the location of the medical device, the tracking information may include manufacturing information and data regarding the device's internal components (e.g., software, firmware, etc.).

When a device is modified in the field, the manufacturer needs to track information regarding the modification to the device, and update its records. Such a modification may include installation of software or firmware, an upgrade to software or firmware, or enablement or disablement of a feature of the device. Conventionally, authorization and reporting of device modifications performed in the field have been manual and paper-based, thereby providing opportunities for human error. For example, when done manually, devices could potentially be modified when not authorized, and modification completion records may have errors or may not be reported at all, affecting device traceability.

There, thus, remains a need for more reliable systems and methods for authorizing and tracking modifications to medical devices.

### SUMMARY OF THE INVENTION

In accordance with a first aspect of the present inventions, a method for authorizing and tracking a modification to a medical device is provided. The modification may, for example, include an installation of software or firmware, an upgrade of software or firmware, an enablement of a feature, and/or a disablement of a feature. The medical device may be an implantable medical device, a clinician programmer, a hand held programmer, a charger, or an external trial stimulator.

The method includes receiving a request for the modification, wherein the request includes identifying information that is specific to the medical device. The step of receiving the request may include receiving the request from the medical device, receiving the request from another device in telemetric communication with the medical device, or receiving the request from a website.

The method further includes confirming that the modification is authorized; generating an authorization key; transmitting the authorization key; receiving a confirmation key indicating that the modification to the medical device has been completed; and updating a database with information about the modification.

In accordance with a second aspect of the present inventions, a method for authorizing and tracking a modification to a medical device is provided. The modification may, for example, be an installation of software or firmware, an upgrade of software or firmware, an enablement of a feature, and/or a disablement of a feature. The medical device may be an implantable medical device, a clinician programmer, a hand held programmer, a charger, or an external trial stimulator.

The method includes transmitting a modification request to a server, wherein the request includes indentifying information that is specific to the medical device. The step of transmitting the modification request may include entering the medical device-specific information into a website, transmitting the request over a network, or transmitting the request over a telephone. The method further includes receiving an authorization key from the server. The method may also include entering the authorization key into the medical device or another device in telemetric communication with the medical device. Still further, the method includes confirming that the authorization key is valid for the medical device and the modification and that the authorization key has not expired, and performing the modification to the medical device. The step of performing the modification to the medical device may include inserting a CD, a dongle or a USB flash drive into the medical device or another device that is in telemetric communication with the medical device. The method also includes generating a confirmation key after the modification is completed, and transmitting the confirmation key to the server.

In accordance with a third aspect of the present inventions, a system for authorizing and tracking a modification to a medical device is provided. The modification may, for example, include an installation of software or firmware, an upgrade of software or firmware, an enablement of a feature, and/or a disablement of a feature. The medical device may include an implantable medical device, a clinician programmer, a hand held programmer, a charger, or an external trial stimulator.

The system includes a server configured for determining whether the modification is authorized for the medical device, and, if the modification is authorized, for generating an authorization key based on information about the medical device and the modification. The system also includes a modification initiating device in communication with the medical device, wherein the initiating device is configured for verifying that the authorization key is valid for the medical device and the modification, for performing the modification to the medical device, and for generating a confirmation key when the modification is complete. The modification initiating device may be a clinician programmer, a hand held programmer, a charger, or an external trial stimulator. The modification initiating device may be in telemetric communication with the medical device. The system further includes a database comprising information about the completed modification to the medical device. The system may also include a CD, dongle, or USB flash drive containing software for implementing the modification.

Other and further aspects and features of the invention will be evident from reading the following detailed description of the preferred embodiments, which are intended to illustrate, not limit, the invention.

### BRIEF DESCRIPTION OF THE DRAWINGS

The drawings illustrate the design and utility of preferred embodiments of the present invention, in which similar elements are referred to by common reference numerals. In order to better appreciate how the above-recited and other advantages and objects of the present inventions are obtained, a more particular description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 is a plan view of a tissue stimulation system for use in conjunction with the methods and systems of the present invention;

FIG. 2 is a block diagram of a system for authorizing and tracking a modification to a medical device, in accordance with one embodiment of the present invention;

FIG. 3 is a block diagram of the internal components of the server of FIG. 2;

FIG. 4 is a block diagram of the internal components of the modification initiating device of FIG. 2;

FIG. 5 is a block diagram of a system for authorizing and tracking a modification to a medical device, in accordance with another embodiment of the present invention; and

FIG. 6 is a is a flow diagram of a method for authorizing and tracking a modification to a medical device using the system of FIG. 2 or FIG. 5.

### DETAILED DESCRIPTION OF THE EMBODIMENTS

The description that follows relates to a tissue stimulation system, e.g., a spinal cord stimulation system, a deep brain stimulation system, or the like. However, it is to be understood that, while the methods and systems described herein lends themselves well to tissue stimulation applications, the methods and systems, in their broadest aspects, are not so limited. Rather, the methods and systems may be used with any type of medical device that may require modification during its lifetime. For example, the methods and systems described herein may be used in conjunction with a pacemaker, a defibrillator, a cochlear stimulator, a retinal stimulator, a stimulator configured to produce coordinated limb movement, a cortical stimulator, a peripheral nerve stimulator, a microstimulator, any other neural stimulator configured to treat urinary incontinence, sleep apnea, shoulder sublaxation, headache, etc., or any other medical device that may require a new program installation, an upgrade, a feature enablement, or a feature disablement.

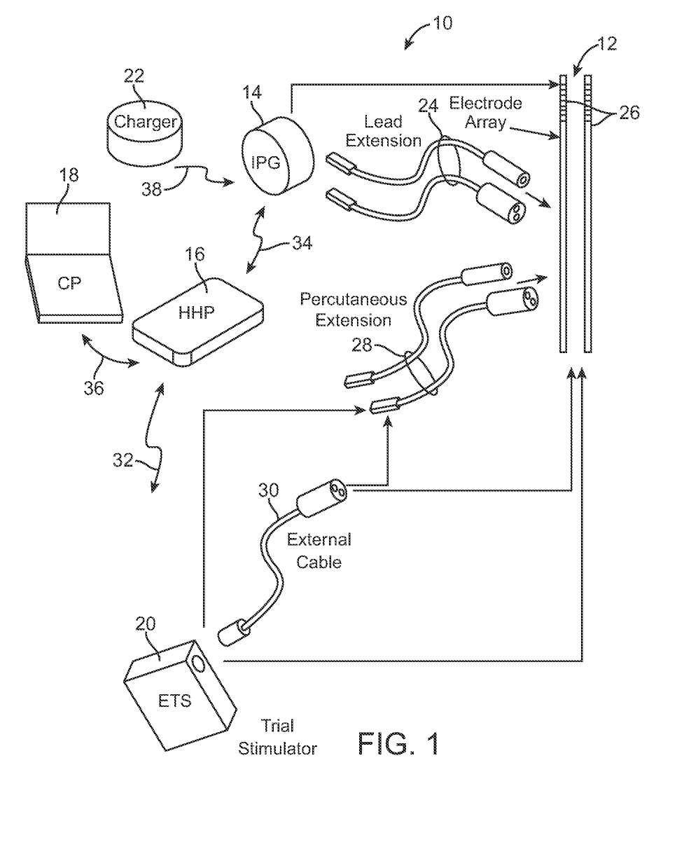

Turning first to FIG. 1, an exemplary tissue stimulation system 10 generally includes one or more (in this case, two) implantable stimulation leads 12, an implantable pulse generator (IPG) 14, an external hand held programmer (HHP) 16, a clinician's programmer (CP) 18, an External Trial Stimulator (ETS) 20, and an external charger 22.

The IPG 14 is physically connected via one or more percutaneous lead extensions 24 to the stimulation leads 12, which carry a plurality of electrodes 26 arranged in an array. In the illustrated embodiment, the stimulation leads 12 are percutaneous leads, and to this end, the electrodes 26 are arranged in-line along the stimulation leads 12. In alternative embodiments, the electrodes 26 may be arranged in a two-dimensional pattern on a single paddle lead. The IPG 14 includes pulse generation circuitry that delivers electrical stimulation energy in the form of a pulsed electrical waveform (i.e., a temporal series of electrical pulses) to the electrode array 26 in accordance with a set of stimulation parameters.

The ETS 20 may also be physically connected via percutaneous lead extensions 28 and external cable 30 to the stimulation leads 12. The ETS 20, which has similar pulse generation circuitry as that of the IPG 14, also delivers electrical stimulation energy in the form of a pulsed electrical waveform to the electrode array 26 in accordance with a set of stimulation parameters. The major difference between the ETS 20 and the IPG 14 is that the ETS 20 is a non-implantable device that is used on a trial basis after the stimulation leads 12 have been implanted and prior to implantation of the IPG 14, to test the responsiveness of the stimulation that is to be provided. The HHP 16 may be used to telemetrically control the ETS 20 via a bi-directional RF communications link 32.

The IPG 14 and the stimulation leads 12 are configured to be implanted within a patient such that the electrodes 26 are in contact with the tissue, e.g., spinal cord tissue or brain tissue, to be stimulated. Once the IPG 14 and stimulation leads 12 are implanted, the HHP 16 may be used to telemetrically control the IPG 14 via a bi-directional RF communications link 34. Such control allows the IPG 14 to be turned on or off and to be programmed with different stimulation parameter sets. The HHP 16 may also be operated to modify the programmed stimulation parameters to actively control the characteristics of the electrical stimulation energy output by the IPG 14.

The CP 18 provides clinician detailed stimulation parameters for programming the IPG 14 and ETS 20 in the operating room and in follow-up sessions. The CP 18 may perform this function by indirectly communicating with the IPG 14 or ETS 20, through the HHP 16, via an IR communications link 36. Alternatively, the CP 18 may directly communicate with the IPG 14 or ETS 20 via an RF communications link (not shown). The clinician detailed stimulation parameters provided by the CP 18 are also used to program the HHP 16, so that the stimulation parameters can be subsequently modified by operation of the HHP 16 in a stand-alone mode (i.e., without the assistance of the CP 18).

The external charger 22 is a portable device used to transcutaneously charge the IPG 14 via an inductive link 38. Once the IPG 14 has been programmed, and its power source has been charged by the external charger 22 or otherwise replenished, the IPG 14 may function as programmed without the HHP 16 or CP 18 being present.

For purposes of brevity, further details of the IPG 14, HHP 16, CP 18, ETS 20, and external charger 22 will not be described herein. Details of exemplary embodiments of these devices are disclosed in U.S. Pat. No. 6,895,280, which is expressly incorporated herein by reference.

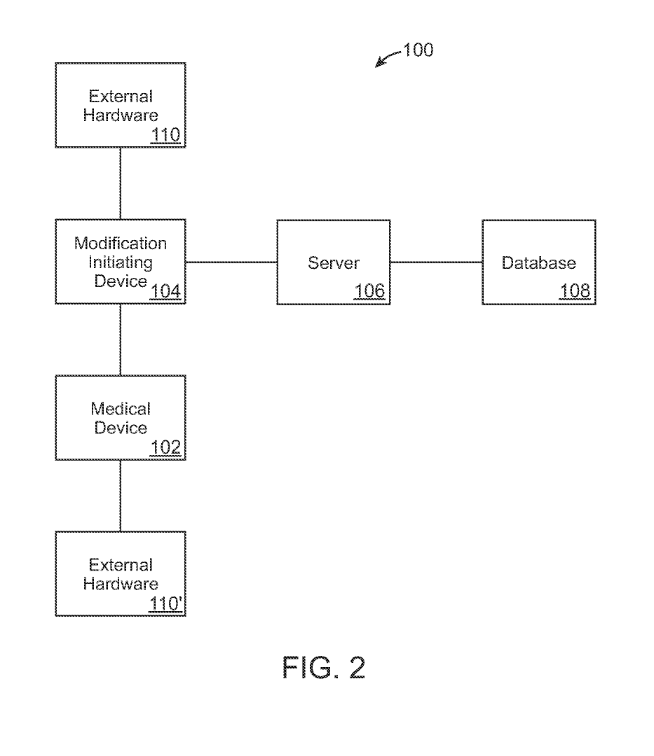

During its lifetime, one or more of the components of the tissue stimulation system 10 may need to be modified, e.g., by installing software or firmware, by upgrading software or firmware, by enabling a feature, by disabling a feature, or the like. Such a modification to the system 10 should be authorized and tracked by the system manufacturer. Thus, turning to FIG. 2, a system 100 for authorizing and tracking a modification to a medical device 102 will be described. The modification to the medical device 102 may include, e.g., an installation of software or firmware, an upgrade to software or firmware, enablement of a feature on the medical device 102, disablement of a feature on the medical device 102, or the like. The medical device 102 may be any internal or external medical device that may require modification. For example, in the tissue stimulation system 10 discussed above, the medical device 102 to be modified may be the IPG 14, HHP 16, CP 18, ETS 20, or charger 22.

In general, the system 100 includes the medical device 102, a modification initiating device 104, a server 106, and a database 108. The system 100 may also include external portable hardware 110 or 110′, e.g., a CD, dongle, or USB flash drive, containing software for implementing the modification. In this embodiment, the external hardware 110 or 110′ is placed in communication with the modification initiating device 104 or the medical device 102, respectively, e.g., by inserting the external hardware 110 or 110′ into the modification initiating device 104 or the medical device 102, by connecting the external hardware 110 or 110′ to the modification initiating device 104 or the medical device 102, or the like. Alternatively, software for implementing the modification may be transmitted to the modification initiating device 104 from the server 106.

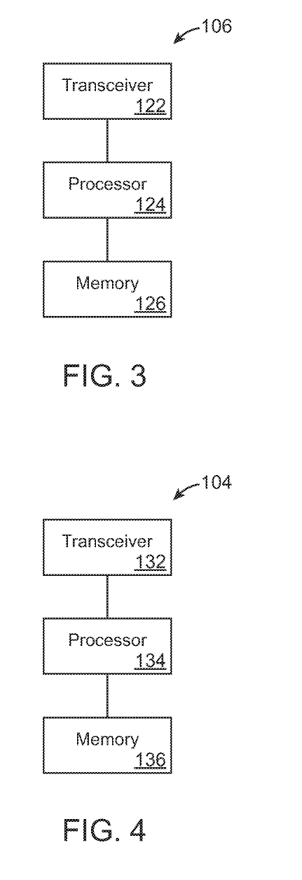

Referring to FIG. 3, the components of the server 106 will now be described. The server 106 generally includes a transceiver 122 for communicating with the modification initiating device 104 and the database 108. The transceiver 122 is configured for receiving a request for the modification from the modification initiating device 104, for transmitting an authorization key to the modification initiating device 104, for receiving a confirmation key from the modification initiating device 104, and for updating the database 108. In alternative embodiments, discussed in more detail below, the transceiver 122 is configured for receiving the modification request from the medical device 102 itself, or from a website. The transceiver 122 may also be configured for downloading the modification to the modification initiating device 104 or to the medical device 102. The server 106 also includes a processor 124 for determining whether the modification is authorized for the medical device 102, and for generating the authorization key. The server 106 further includes memory 126 for storing information, such as instructions for performing the modification, information related to the authorization keys, information related to the confirmation keys, medical device-specific information, information related to the requested and/or completed modification to the medical device 102, or the like. The server 106 may be maintained by the medical device manufacturer.

The authorization key generated by the server 106 is based on information about the medical device 102 and the requested modification. In this system 100, the authorization key enables the modification to the medical device 102. Without the authorization key, the medical device 102 may not be modified. Thus, the system 100 prevents unauthorized modifications to the medical device 102.

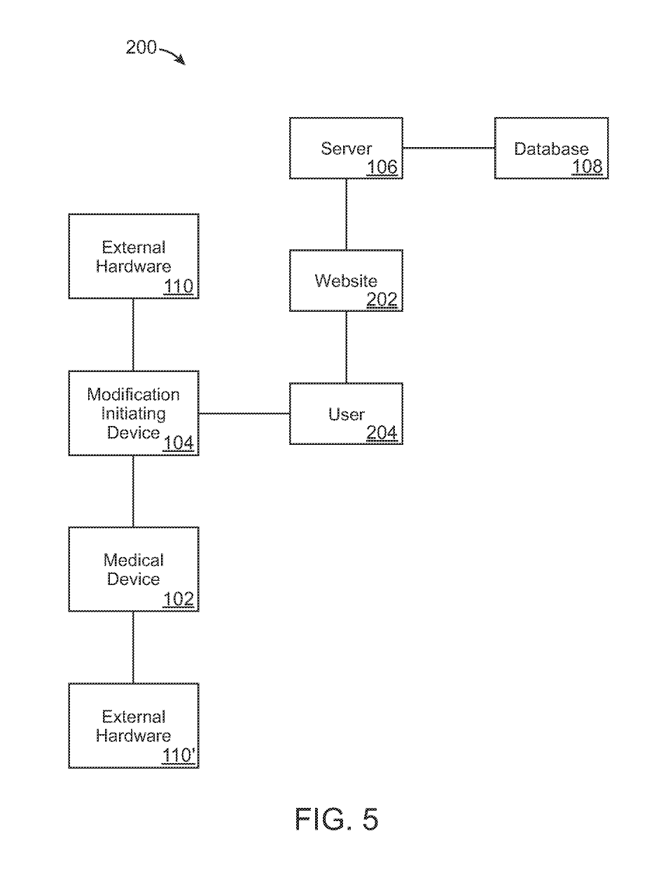

Referring to FIG. 4, the components of the modification initiating device 104 will now be described. The modification initiating device 104 generally includes a transceiver 132 for communicating with the server 106 and the medical device 102. The transceiver 132 is configured for gathering medical device-specific information from the medical device 102, for transmitting the modification request, including the medical device-specific information, to the server 106, for receiving the authorization key from the server 106, for downloading the modification to the medical device 102, and for transmitting the confirmation key to the server 106. In an alternative embodiment, discussed in more detail below with reference to FIG. 5, the transceiver 132 does not communicate directly with the server 106. Rather, user intervention is required for the modification initiating device 104 to receive the authorization key from the server 106 and transmit the confirmation key to the server 106. The modification initiating device 104 also includes a processor 134 for verifying that the authorization key is valid for the medical device 102 and the requested modification, for performing the modification to the medical device 102, and for generating the confirmation key when the modification is complete. The modification initiating device 104 further includes memory 136 for storing information, such as instructions for performing the modification, information related to the authorization keys, information related to the confirmation keys, medical device-specific information, information related to the requested and/or completed modification to the medical device 102, or the like. In the tissue stimulation system 10 described above, the modification initiating device 104 may, for example, be the HHP 16, the CP 18, the ETS 20, or the charger 22.

The confirmation key generated by the modification initiating device 104 is based on information about the medical device 102 and the modification. The confirmation key confirms that the modification to the medical device 102 was performed and is required in order for the database 108 to be updated. Thus, the system 100 accurately tracks modifications made to the medical device 102.

Referring again to FIG. 2, the database 108 includes information about the completed modification to the medical device 102. The database 108 may be maintained by the manufacturer of the medical device 102 in order to track the status of the medical device 102. The database 108 may be configured to store information regarding a plurality of medical devices manufactured by the manufacturer. In this manner, the server 106 is configured to track a plurality of medical devices and modifications to the medical devices by updating the database 108 each time a modification is made to a medical device.

In an alternative embodiment, the modification initiating device 104 and the medical device 102 may be a single component. That is, the modification initiating device 104 may be configured for initiating the modification and then performing the modification on itself. For example, in the tissue stimulation system 10 described above, the HHP 16, the CP 18, the ETS 20, or the charger 22 may be the medical device 102 requiring modification, and the HHP 16, the CP 18, the ETS 20, or the charger 22 may also be the modification initiating device 104.

The modification initiating device 104 may be in telemetric communication with the medical device 102. That is, communication between the medical device 102 and the modification initiating device 104 may be through a wireless data transfer mechanism. For example, communication between the medical device 102 and the modification initiating device 104 may be through an RF communications link, an IR communications link, or the like. Alternatively, the medical device 102 and the modification initiating device 104 may communicate through a wired connection.

Communication between the modification initiating device 104 and the server 106 may be over phone lines, over the web, via device-to-device communication over a network, etc. The authorization and confirmation keys may be transmitted automatically between the modification initiating device 104 and the server 106, e.g., if the modification initiating device 104 is internet-enabled. Alternatively, transmission of the authorization and confirmation keys may require user intervention, as shown in FIG. 5 and discussed in greater detail below. Still alternatively, the authorization and confirmation keys may be transmitted via an intermediary device, e.g., a CD, dongle, or USB flash drive. The key exchange may occur via manual typing on either or both ends.

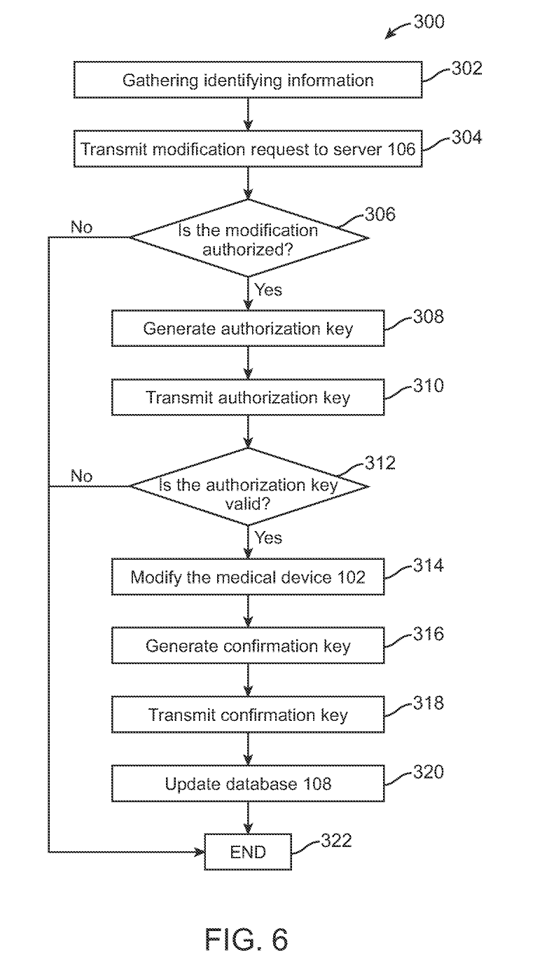

A method 300 for authorizing and tracking a modification to a medical device 102 is shown in FIG. 6. In one embodiment, the method 300 utilizes the system shown in FIG. 2. In this embodiment, the modification initiating device 104 gathers medical device-specific identifying information from the medical device 102 in step 302. The modification initiating device 104 then transmits a modification request, including the medical device-specific identifying information, to the server 106 in step 304. The server 106 then determines, in step 306, whether the modification is authorized. If the modification is authorized, the server 106 generates an authorization key in step 308, and transmits the authorization key to the modification initiating device 104 in step 310. The authorization key may include medical device-specific information, information regarding the modification to be performed, an expiration date and time, and/or the like. If the modification is not authorized, the method 300 is terminated and the medical device 102 is not modified.

In step 312, the modification initiating device 104 determines whether the authorization key is valid for the medical device 102 and for the modification to be performed and verifies that the key has not expired. If the modification initiating device 104 determines that the authorization key is valid, the modification initiating device 104 performs the modification to the medical device 102 in step 314. Step 314 of performing the modification may include inserting external hardware 110 or 110′ into, or connecting external hardware 110 or 110′ to, the modification initiating device 104 or the medical device 102. If the modification initiating device 104 determines that the authorization key is not valid, the modification is not performed and the method 300 is terminated. Once the modification is complete, the modification initiating device 104 generates a confirmation key in step 316, and transmits the confirmation key to the server 106 in step 318. The confirmation key may include information regarding the success or failure of the modification to the medical device 102. After receiving the confirmation key, the server 106 updates the medical device history information in the database 108 in step 320.

In another embodiment, user intervention is required for communication between the modification initiating device 104 and the server 106. For example, as shown in FIG. 5, in a system 200 for authorizing and tracking a modification to the medical device 102, a user 204 may be required to enter medical device-specific information into a website 202. The website 202 then transmits the medical device-specific information to the server 106. The user 204 may also be required to enter authorization key data into the modification initiating device 104 using, for example, an entry field displayed on the modification initiating device 104.

In another embodiment of the method 300 shown in FIG. 6 for authorizing and tracking a modification to the medical device 102, the system 200 shown in FIG. 5 is used. Similar to the embodiment discussed above, the method 300 begins with the step 302 of the modification initiating device 104 gathering medical device-specific identifying information from the medical device 102. Then, the step 304 of transmitting a modification request to the server 106 includes the modification initiating device 104 displaying the medical device-specific information and the user 204 entering the medical device-specific information into the website 202. The website 202 then transmits the information to the server 106. The server 106 then determines, in step 306, whether the modification is authorized. If the modification is authorized, the server 106 generates an authorization key in step 308. If the modification is not authorized, the method 300 is terminated and the medical device 102 is not modified.

In this embodiment, the step 310 of transmitting the authorization key requires user intervention. For example, the server 106 may transmit the authorization key to the website 202 and authorization key information may be displayed on the website 202. Then, the user 204 transmits the authorization key information to the modification initiating device 104 by entering the information into an entry field displayed on the modification initiating device 104. In an alternative embodiment where the medical device 102 and the modification initiating device 104 are the same component, the user 204 enters the authorization key information into an entry field displayed on the medical device 102.

In step 312, the modification initiating device 104 determines whether the authorization key is valid for the medical device 102 and for the modification to be performed and verifies that the key has not expired. If the modification initiating device 104 determines that the authorization key is valid, the modification initiating device 104 performs the modification to the medical device 102 in step 314. If the modification initiating device 104 determines that the authorization key is not valid, the modification is not performed and the method 300 is terminated. Once the modification is complete, the modification initiating device 104 generates a confirmation key in step 316. In this embodiment, the step 318 of transmitting the confirmation key to the server 106 may require user intervention. For example, the modification initiating device 104 may display confirmation key information and the user 204 may be required to enter the confirmation key information into the website 202. The website 202 then transmits the confirmation key information to the server 106. After receiving the confirmation key, the server 106 updates the medical device history information in the database 108 in step 320.

Although particular embodiments of the present inventions have been shown and described, it will be understood that it is not intended to limit the present inventions to the preferred embodiments, and it will be obvious to those skilled in the art that various changes and modifications may be made without departing from the spirit and scope of the present inventions. Thus, the present inventions are intended to cover alternatives, modifications, and equivalents, which may be included within the spirit and scope of the present inventions as defined by the claims.

What is claimed is:

1. A method for authorizing and tracking a modification to a medical device, the method comprising:
receiving a request for the modification, wherein the request includes identifying information that is specific to the medical device;
confirming that the modification is authorized;
generating an authorization key;
transmitting the authorization key; and
receiving a confirmation key indicating that the modification to the medical device has been completed.

2. The method of claim 1, wherein the modification comprises at least one of an installation of software or firmware, an upgrade of software or firmware, an enablement of a feature, and a disablement of a feature.

3. The method of claim 1, wherein the medical device comprises one of an implantable medical device, a clinician programmer, a hand held programmer, a charger, and an external trial stimulator.

4. The method of claim 1, wherein receiving the request comprises receiving the request from the medical device.

5. The method of claim 1, wherein receiving the request comprises receiving the request from another device in telemetric communication with the medical device.

6. The method of claim 1, wherein receiving the request comprises receiving the request from a website.

7. The method of claim 1, further comprising updating a database with information about the modification.

8. A method for authorizing and tracking a modification to a medical device, the method comprising:
transmitting a modification request to a server, wherein the request includes indentifying information that is specific to the medical device;
receiving an authorization key from the server;
confirming that the authorization key is valid for the medical device and the modification and that the authorization key has not expired;
performing the modification to the medical device;
generating a confirmation key after the modification is completed; and
transmitting the confirmation key to the server.

9. The method of claim 8, wherein the modification comprises at least one of an installation of software or firmware, an upgrade of software or firmware, an enablement of a feature, and a disablement of a feature.

10. The method of claim 8, wherein the medical device comprises one of an implantable medical device, a clinician programmer, a hand held programmer, a charger, and an external trial stimulator.

11. The method of claim 8, wherein transmitting the modification request comprises entering the medical device-specific information into a website.

12. The method of claim 11, further comprising entering the authorization key into the medical device or another device in telemetric communication with the medical device.

13. The method of claim 8, wherein transmitting the modification request comprises transmitting the request over a network.

14. The method of claim 8, wherein transmitting the modification request comprises transmitting the request over a telephone.

15. The method of claim 8, wherein performing the modification to the medical device comprises inserting a CD, a dongle or a USB flash drive into the medical device or another device that is in telemetric communication with the medical device.

16. A system for authorizing and tracking a modification to a medical device, wherein the system comprises:
a server configured for determining whether the modification is authorized for the medical device, and, if the modification is authorized, for generating an authorization key based on information about the medical device and the modification;
a modification initiating device configured for communicating with the medical device, for verifying that the authorization key is valid for the medical device and the modification, for performing the modification to the medical device, and for generating a confirmation key when the modification is complete; and
a database comprising information about the completed modification to the medical device.

17. The system of claim 16, wherein the modification comprises at least one of an installation of software or firmware, an upgrade of software or firmware, an enablement of a feature, and a disablement of a feature.

18. The system of claim 16, wherein the medical device comprises one of an implantable medical device, a clinician programmer, a hand held programmer, a charger, and an external trial stimulator.

19. The system of claim 16, wherein the modification initiating device is one of a clinician programmer, a hand held programmer, a charger, and an external trial stimulator.

20. The system of claim 16, further comprising a CD, dongle, or USB flash drive containing software for implementing the modification.
